(19) United States
(12) Patent Application Publication
(10) Pub. No.: US 2012/0203362 A1
(43) Pub. Date: Aug. 9, 2012

(54) METHOD AND DEVICE FOR FORMING A MIXED SIGNAL, METHOD AND DEVICE FOR SEPARATING SIGNALS, AND CORRESPONDING SIGNAL

(75) Inventors: Mathieu Parvaix, Grenoble (FR); Laurent Girin, Grenoble (FR); Jean-Marc Brossier, Saint Martin D'heres (FR); Sylvain Marchand, Pessac (FR)

(73) Assignees: Universite Bordeaux 1, Talence (FR); Institut Polytechnique de Grenoble, Grenoble (FR)

(21) Appl. No.: 13/262,428

(22) PCT Filed: Mar. 30, 2010
(86) PCT No.: PCT/FR2010/050583

§ 371 Date: Apr. 25, 2012

(30) Foreign Application Priority Data
Apr. 10, 2009 (FR) 0952397

(51) Int. Cl. G06F 17/00

(52) U.S. Cl. 700/94

(57) ABSTRACT

The invention relates to a method of formation of one or more mixed signals (Sₒᵤₜ) on the basis of at least two digital source signals (S₁, S₂), in particular audio signals, in which the mixed signal or signals (Sₒᵤₜ) are formed by mixing the source signals (S₁, S₂). In particular, a quantity characteristic of a source signal or of the mixing is determined and the value (W₁, W₂) of the said characteristic quantity is watermarked on at least one of the signals (S₁, S₂, Sₒᵤₜ).

The invention also relates to a method of separation intended to separate, at least partially, at least one digital source signal contained in one or more mixed signals comprising a watermarked value of a quantity characteristic of a source signal or of the mixing. According to the method, the watermarked value of the quantity characteristic of the source signal or of the mixing is determined, and then the mixed signal or signals is or are processed as a function of the said value so as to obtain, at least partially, the said source signal.

The invention also relates to the corresponding mixed signal (Sₒᵤₜ), as well as the corresponding devices.

The present invention relates to a method intended to separate at least one of the component source signals making up a global signal. The invention also relates to a method for forming a global signal allowing the subsequent separation of a t least one component source signal thereof. Finally, the invention relates to devices intended to implement these methods.

The mixing of signals consists in summing several signals, called source signals, to obtain one or more composite signals, called mixed signals. In audio applications in particular, mixing can consist of a simple step of adding the source signals or can also comprise steps of filtering the signals before and/or after addition. Moreover, for certain applications such as audio compact disc, the source signals may be mixed in a different manner to form two mixed signals corresponding to the two pathways (left and right) of a stereo signal.

The separation of sources consists in estimating source signals on the basis of the observation of a certain number of different mixed signals formed on the basis of these same source signals. The objective is generally to augment, or indeed if possible to extract one or more target source signals completely. The separation of sources is in particular difficult in so-called “under-determined” cases in which a smaller number of mixed signals is available than the number of source signals present in the mixed signals. Extraction is in this case very difficult or indeed impossible because of the scant amount of information available in these mixed signals with respect to that present in the source signals. Music signals on audio compact disc are a particularly representative example thereof since only two stereo pathways (that is to say two mixed signals), generally highly redundant, are available for a large potential number of source signals.

There exist several types of approaches to the separation of source signals: these include blind separation, computational auditory scene analysis, and separation based on models. Blind separation is the most general form, in which no information about the source signals or about the nature of the mixed signals is known a priori. A certain number of assumptions are then made about these source signals and the mixed signals (for example that the source signals are statistically independent) and the parameters of a separating system are estimated by maximizing a criterion based on these assumptions (for example by maximizing the independence of the signals obtained by the separating device). However, this procedure is generally used in cases where numerous mixed signals (at least as many as source signals) are available and is therefore not applicable to under-determined cases in which the number of mixed signals is smaller than the number of source signals.

The analysis of computational auditory scenes consists in modelling the source signals as harmonic partials, but the mixed signal is not decomposed explicitly. This procedure is based on the mechanisms of the human auditory system to separate the source signals in the same manner as does our ear. It is in particular possible to cite: D. P. W. Ellis, Using knowledge to organize sound: The prediction-driven approach to computational auditory scene analysis, and its application to speech/non-speech mixture (Speech Communication, 27(3), pp. 281-298, 1999), D. Godsmark and G. J. Brown, A blackboard architecture for computational auditory scene analysis (Speech Communication, 27(3), pp. 351-366, 1999), and likewise T. Kinoshita, S. Sakai and H. Tanaka, Musical sound source identification based on frequency component adaptation (In Proc. IJCAI Workshop on CASA, pp. 18-24, 1999). However, the analysis of computational auditory scenes generally leads to poor results regarding the separation of source signals, in particular in the case of audio signals.

Another form of separation relies on a decomposition of the mixture over a basis of adapted functions. Two large categories thereof exist: temporal parsimonious decomposition and parsimonious decomposition by frequency.

The former entails decomposing the waveform of the mixture, and the latter entails decomposing its spectral representation, into a sum of elementary functions called “atoms”, elements of a dictionary. Diverse algorithms make it possible to choose the type of dictionary and the most likely corresponding decomposition. In respect of the temporal domain, it is possible to cite in particular: L. Benaroya, Représentations parcimonieuses pour la séparation de sources avec un soul capteur [Parsimonious representations for the separation of sources with a single sensor] (Proc. GRETSI, 2001), or P. J. Wolfe and S. J. Godsill, A Gabor regression scheme for audio signal analysis (Proc. IEEE Workshop on Applications of Signal Processing to Audio and Acoustics, pp. 103-106, 2003). In the procedure proposed by Gribonval (R. Gribonval and E. Bacry, Harmonic Decomposition of Audio Signals With Matching Pursuit, IEEE Trans. Signal Proc., 51(1), pp. 101-112, 2003), the decomposition atoms are classed into independent sub-spaces, thereby making it possible to extract groups of harmonic partials. One of the restrictions of this procedure is that generic dictionaries of atoms such as Gabor atoms for example, not adapted to the signals, do not give good results. Moreover, in order for these decompositions to be effective, it is necessary for the dictionary to contain all the translated forms of the waveforms of each type of instrument. The decomposition dictionaries then have to be extremely voluminous in order for projection and therefore separation to be effective.

To alleviate this problem of invariance under translation which appears in the temporal case, approaches of parsimonious decomposition by frequency exist. It is possible to cite in particular M. A. Casey and A. Westner (Separation of mixed audio sources by independent subspace analysis, Proc. Int. Computer Music Conf., 2000) who have introduced independent sub-space analysis (ISA). This analysis consists in decomposing the short-term amplitude spectrum of the mixed signal (calculated by short-term Fourier transform (STFT)) over a basis of atoms, and thereafter in grouping the atoms together into independent sub-spaces, each sub-space being specific to a source, and thereafter to resynthesize the sources separately. However, this approach is generally limited by several factors: the resolution of the spectral analysis by STFT, the superposition of the sources in this spectral domain, and the restriction of the spectral separation to the amplitude (the resynthesized phase of the signals being that of the mixed signal). It is thus generally difficult to represent the mixed signal as a sum of independent sub-spaces on account of the complexity of the sound scene in the spectral domain (strong imbrication of the various components) and because of the evolution, as a function of time, of the contribution of each component in the mixed signal. In fact, the procedures are often evaluated on well-controlled “simplified” mixed signals (the source signals are MIDI instruments or are relatively well separable instruments, fairly few in number).

It is also possible to also cite L. Benaroya, F. Bimbot and R. Gribonval Audio sources separation with a single sensor (IEEE Trans. Audio, Speech, & Language Proc., 14(1), 2006) who use statistical models of the various sources. However, the parameters of these models are adjusted on the basis of examples of audio tracks of the various instruments to be separated.

S. D. Teddy and E. Lai, Model-based approach to separating instrumental music from single track recordings (Int. Conf. Control, Automation, Robotics and Vision, Kunming, China, 2004) use a neural net to “learn” characteristics of diverse musical instruments. They extract auditory characteristics of the timbre of the piano by virtue of a model of auditory images, and then attempt to highlight these characteristics in the mixture so as to isolate the piano.

K. I. Molla and K. Hirose, Single-Mixture audio source separation by subspace decomposition of Hilbert spectrum (IEEE Trans. Audio, Speech, & Language Proc., 15(3), 2007) have worked on separation of sources by a decomposition of the Hilbert spectrum of the mixture into independent sub-spaces, the Hilbert transform providing better results for discriminating the various sources than the Fourier transform.

N. Cho, Y. Shiu and C.-C. J. Kuo, Audio source separation with matching pursuit and content-adaptive dictionaries (IEEE Workshop on Applications of Signal Processing to Audio and Acoustics, 2007) propose separation by decomposition of the mixture over a basis of Gabor atoms learnt for a particular instrument, and for the various notes of this instrument. By the “matching pursuit” technique, some of these atoms are retained and then gathered into a sub-space adapted to the note extracted.

Finally, Y.-W. Liu, Sound source segregation assisted by audio watermarking (IEEE, Int. Conf. Multimedia and Expo., pages 200-203, 2007) proposes to mark the source signals with an identification of the source signal from which they arise. In particular, the marking is carried out in such a way as to separate, in the frequency spectrum of the mixed signal, the frequencies arising from each source signal. However, the number of sources that can be separated in this manner is limited, Moreover, it is not conceivable to mark all the frequencies contained in a source signal: there may then be superposition of a non-marked frequency of a source signal with a marked frequency of the other source signal.

For all these studies, the tests are performed on rather unrealistic artificial mixtures and under very controlled conditions with respect to the real cases to which they are intended to be applied.

Moreover, the separation procedures based on underdetermined mixtures exhibit limited effectiveness because of the lack of available information, other than that provided by the mixed signals themselves.

An aim of the present invention is therefore to propose a method making it possible to separate a source signal included in a mixed signal, in a more effective manner. In particular, an aim of the invention is to propose a method for separating a source signal in so-called “under-determined” cases in which the number of mixed signals is smaller than the number of source signals.

For this purpose, in one embodiment, there is proposed a method of formation of one or more mixed signals on the basis of at least two digital source signals, in particular audio signals, in which the mixed signal or signals are formed by mixing the source signals. In particular, a quantity characteristic of a source signal or of the mixing is determined and the value of the said characteristic quantity is watermarked on at least one of the signals.

There is also proposed a method of separation intended to separate, at least partially, at least one digital source signal contained in one or more mixed signals obtained by mixing source signals, comprising a watermarked value of a quantity characteristic of a source signal or of the mixing. According to the method, the watermarked value of the quantity characteristic of the source signal or of the mixing is determined, and then the mixed signal or signals is or are processed as a function of the said value so as to obtain, at least partially, the said source signal.

Watermarking consists, in all generality, in adding a binary item of information to a digital signal. In particular, watermarking is used to insert information relating to the content represented by the signal. Thus, in the case where the signal represents a photograph or a song, the watermarked information may be for example the author of the photograph or of the song.

The techniques of audio watermarking arc considered hereinafter. The watermarking of a signal exploits the defects of the human perceptive system so as to insert into a signal, in this instance a sound signal, an item of information which is preferably imperceptible, that is to say inaudible. Typically, the techniques employed are of spread spectrum type (R. Garcia: Digital watermarking of audio signals using psychoacoustic auditory model and spread spectrum theory, 107th Convention of Audio Engineering Society (AES), 1999), (Cox, I. J., Kilian, J., Leighton, F. T., Shamoon, T.: Secure spread spectrum watermarking for multimedia, IEEE Transactions on Image Processing, 6(12), pp. 1673-1687; 1997). Generally, audio watermarking is used within the framework of the protection and control of copyrights (“Digital Rights Management”) for works on digital medium, and more generally within the framework of the traceability of information on this type of medium. Thus, information making it possible to identify the author or the owner of a song can be watermarked on this song. In this ease, the objective is to insert in a very robust manner (that is to say one which is resistant to possible, more or less licit, manipulations of the signal) information of relatively small amount spread over a wide time-frequency span of the signal and then added to the latter, so that it is very difficult to be able to isolate it in order to delete it.

When the host signal is known at the emitter (where the watermark is formed), one may speak of “informed watermarking” (“watermarking with side-information”). The aim in this case is to choose an optimal watermarking adapted to the signal on which it is inserted (I. J. Cox, M. L. Miller and A. L. McKellips, Watermarking as communications with side information, IEEE Proc., 87(7), pp. 1127-1141, 1999). The constraints to be satisfied are to obtain the highest possible transmission throughput but without the watermarking being audible, and also to ensure the best possible reliability of transmission (few errors made in the course of transmission). Watermarking for the transmission of data is thus used inter alia for the annotation of documents with a view for example to indexing in a database (Ryuki Tachibana: Audio watermarking for live performance, SPIE Electronic Imaging: Security and Watermarking of Multimedia Content V, volume 5020, pp. 32-43; 2003), or the identification of documents with the aim of compiling statistics on the broadcasting of this document for example (T. Nakamura, R. Tachibana & S. Kobayashi, Automatic music monitoring and boundary detection for broadcast using audio watermarking, SPIE Electronic Imaging: Security and Watermarking of Multimedia Content IV, vol. 4675, pp. 170-180, 2002). Within the framework of watermarking for data transmission; it is possible to also cite the technique of substitutive watermarking in which the characteristics of the host signal are replaced with those of the watermark. Examples of substitutive watermarks are described by Chen (B. Chen and C.-E. W. Sundberg: Digital audio broadcasting in the fm band by means of contiguous band insertion and precanceling techniques, IEEE Transactions on Communications, 48(10), pp. 1634-1637, 2000), or else by Bourcet (P. Bourcet, D. Masse and B. Jahan: Système de diffusion de données [Data broadcasting system], 1995. Patent of Invention 95 06727, Télédiffusion de France).

It is possible to use, in the present case, a watermarking scheme inspired by the investigations of Chen and Wornell (B. Chen & G. Wornell, Quantization index modulation: a class of provably good methods for digital watermarking and information embedding. IEEE Trans. Information Theory, 47, pp. 1423-1443, 2001). In these investigations, the watermark is introduced by quantization. In a simplified manner, the watermark is carried by a modification of the quantization levels, in one of the representations of the host signal (temporal, spectral or spectro-temporal representation). The theoretical performance of this technique approaches Costa's model (M. Costa, Writing on dirty paper, IEEE Trans. Information Theory, 29, pp. 439-441, 1983) which fixes the theoretical limit of the transmission capacity of a transmission chain if the signal is known a priori at the emitter.

In the present case, the watermark is used to insert an item of information relating to the signal itself, allowing separation of the source signals on the basis of the mixed signal. The item of information inserted pertains here to the source signals themselves (for example their energy distribution over time, in frequency, or else in the time-frequency plane), to the source signals and the mixed signal (for example the contribution of each source signal in the mixed signal, on a more or less local scale in the time-frequency plane), or else to the mixing method itself (parameters of the mixing step that led to the mixed signal). It thus entails quantities characteristic of the source signals and/or of the mixing, that is to say descriptors characteristic of the source signals and/or of the mixing in the signal processing sense, these descriptors having to make it possible to aid the separation of the signals. Here this therefore entails an item of information which is at one and the same time relatively voluminous and optionally distributed in a well-localized and well-controlled manner in the time-frequency plane. On the other hand, the watermark does not need to exhibit particular robustness properties, in particular with respect to illicit manipulations that the signal might undergo. Thus, procedures of non-secure type, that is to say procedures which are not very robust to manipulations of the signal but which make it possible to watermark information in larger amounts, may be considered as watermarking procedures.

The association of a watermarking method and of a method for separating sources allows an improvement of the effectiveness of separation of a source signal on the basis of a mixed signal, in so far as it entails informed separation: at the moment of separation, information is known about at least one source signal before mixing or about parameters of the mixing method itself. In particular, in so-called “under-determined” cases, even with a single mixed signal, separation remains possible by virtue of the information relating to the source signals themselves, which is watermarked in the mixed signal. Stated otherwise, watermarking provides the information required for obtaining effective separation, even with a high number of source signals.

The characteristic quantity is watermarked in the signal in such a way as to hardly modify the signal and in such a way as not to modify its format. In particular, in the case of audio signals, the watermarked mixed signal remains compatible with a conventional reader of compact discs, and the watermarked value is inserted in such a way as to be hardly, if at all, audible. It is then possible to read the mixed signal according to already-known methods, even though signal separation is not handled by these methods.

Preferably, the characteristic quantity represents the temporal, spectral or spectro-temporal energy distribution of at least one source signal. The quantity is in this case characteristic of at least one source signal. It is chosen in such a way as to allow effective separation while limiting the amount of information to be watermarked in the mixed signal. Thus, according to the characteristics of the source signal, the characteristic quantity will be more or less accurate and more or less voluminous, to obtain similar separation.

Alternatively, the characteristic quantity can represent the spectral contribution in amplitude or in energy, at at least one determined instant, of at least one of the source signals in the mixed signal or signals. In this case, it entails a relative quantity between the source signal or signals and the mixed signal or signals, and this quantity is characteristic of the source signal or signals with respect to the mixed signals.

Finally, the characteristic quantity can represent the parameters for the mixing of the source signals so as to obtain the mixed signal. It may involve for example the set of weighting parameters, and of filtering parameters if appropriate, associated with each source signal during the mixing step. In this case, the quantity represents the various parameters for weighting or filtering the source signals during the mixing determining the mixed signal thus obtained, and this quantity is characteristic of the mixing. In particular, for stereo signals, it is possible in certain cases, in spite of the under-determined character of the separation problem, to exploit the knowledge of the mixing method to at least partially separate a source signal.

The value of the said characteristic quantity may be watermarked on the source signal or signals before mixing and/or on the mixed signal or signals after mixing. In all cases, the determination and the watermarking of this characteristic quantity require the knowledge of the source signals, and/or that of the mixed signal or signals, and/or that of the mixing method.

According to another aspect, there is proposed a device for forming one or more mixed signals on the basis of at least two digital source signals, in particular audio signals, comprising a means for mixing the said source signals so as to form the mixed signal or signals. The device also comprises a means for determining a quantity characteristic of a source signal or of the mixing, and a means for watermarking the value of the said characteristic quantity on at least one of the signals.

There is also proposed a separating device intended to separate, at least partially, at least one digital source signal contained in one or more mixed signals obtained by mixing source signals, comprising a watermarked value of a quantity characteristic of a source signal or of the mixing. The device comprises a means for determining the watermarked value of the quantity characteristic of the source signal or of the mixing, and a means for processing the mixed signal or signals as a function of the said value, able to obtain, at least partially, the said source signal.

According to one embodiment of the forming device, the watermarking means is mounted upstream of the mixing means and is capable of watermarking the value of the characteristic quantity on the source signal or signals.

According to another embodiment of the forming device, the watermarking means is mounted downstream of the mixing means and is capable of watermarking the value of the characteristic quantity on the mixed signal or signals.

The forming device can also comprise a means for quantizing a representation of a signal, in which the watermarking means marks the value of the characteristic quantity by using over-levels of quantization of the representation of the signal. The representation of the signal may be a spectral or spectro-temporal representation of the signal.

In particular, the quantization means makes it possible to determine the amplitude of the modifications that may be introduced into the representation of the signal, in such a way that these modifications do not alter the perceived quality of the signal when the latter is restored by a conventional reading device or by a separating device according to the invention, and in such a way that these modifications can be detected by a separating device according to the invention.

It is thus possible to obtain a signal watermarked with a characteristic quantity, such that the quality of the sound content represented by t his watermarked signal is hardly, if at all, degraded with respect to that of the sound content represented by the initial signal. The restoration of the watermarked signal by a known device will make it possible to obtain a sound content quality which is hardly, if at all, modified, while the processing of the signal watermarked by a device according to the invention will make it possible to determine the value watermarked in the signal.

According to another aspect, there is proposed a mixed signal, in particular an audio signal, obtained by mixing at least two source signals, comprising a watermarked value of a quantity characteristic of a source signal or of the mixing.

There is also proposed an information medium, in particular an audio compact disc, comprising the said mixed signal.

The invention will be better understood on studying a particular embodiment; taken by way of wholly non-limiting example and illustrated by the appended drawings in which:

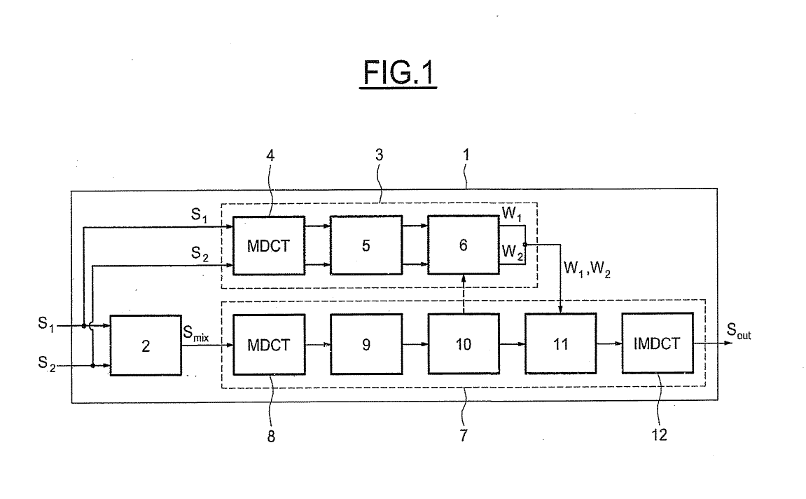

FIG. 1 schematically represents a first embodiment of a device for forming a mixed signal according to the invention;

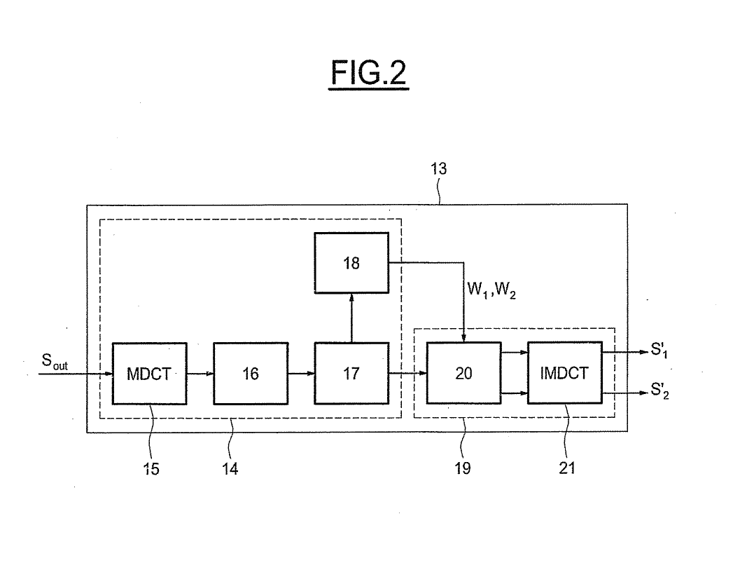

FIG. 2 schematically represents a first embodiment of a separating device according to the invention;

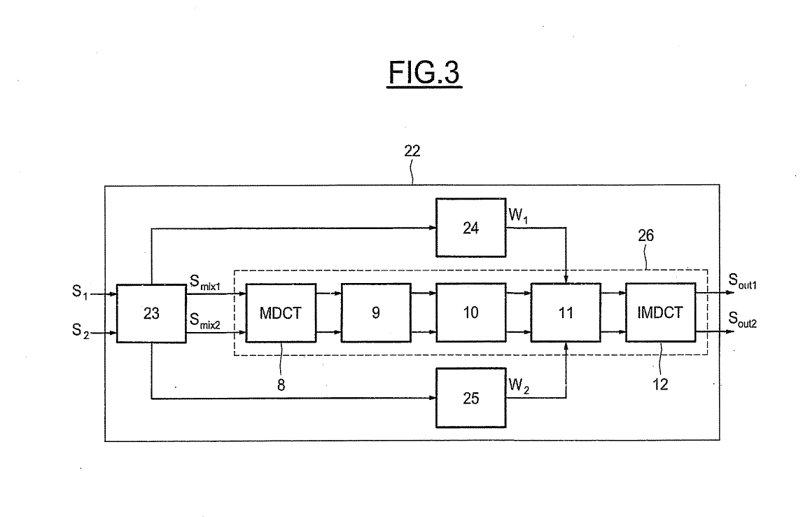

FIG. 3 schematically represents a second embodiment of a device for forming a mixed signal according to the invention;

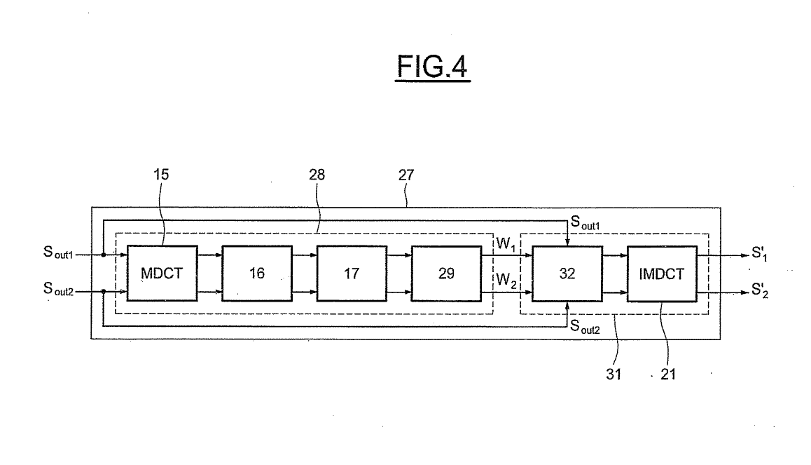

FIG. 4 schematically represents a second embodiment of a separating device according to the invention;

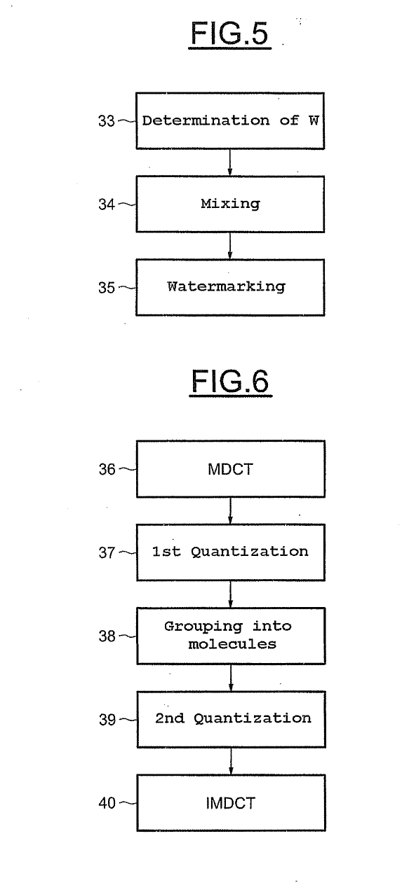

FIG. 5 is a flow chart of a method for forming a mixed signal according to the invention;

FIG. 6 is a flow chart of a watermarking method, and

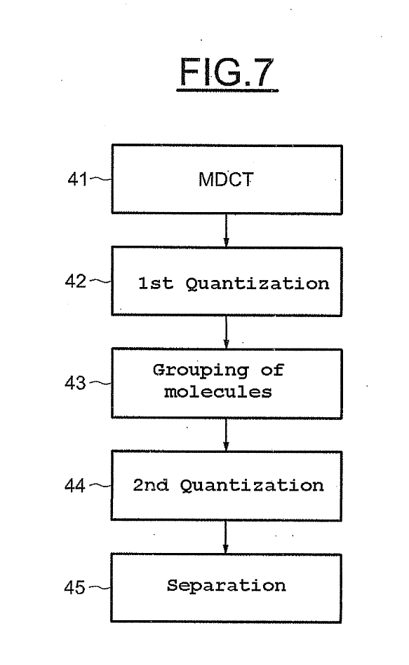

FIG. 7 is a flow chart of a method of separation according to the invention.

In FIG. 1 there has been schematically represented a first embodiment of a device 1 for forming a mixed signal. The forming device 1 receives as input the source signals S₁ and S₂, and delivers a mixed signal Sₒᵤₜ. Here, for simplification purposes, the number of source signals has been limited to two. However, it will be understood that the number of source signals may be much higher. Moreover, it is considered in the subsequent description, that the signals are audio signals. The aim of the forming device 1 is to deliver a mixed signal Sₒᵤₜ formed on the basis of the source signals S₁, S₂ and comprising the watermarked value of a quantity characteristic of at least one of the source signals.

The device comprises a mixing means 2. The mixing means also receives as input the source signals S₁ and S₂, and delivers as output an initial mixed signal Sₘᵢₓ resulting from a combination of the source signals. In particular, the mixing can consist of a simple summation. It can also involve a summation whose coefficients assigned to each source signal vary over time, or else a summation associated with one or more filters.

According to this embodiment, the mixed signal Sₒᵤₜ comprises the watermarked value of a quantity characteristic of at least one of the source signals S₁, S₂. It is considered in the subsequent description that the mixed signal Sₒᵤₜ comprises the watermarked values of a quantity characteristic of each source signal.

The forming device 1 thus comprises a means 3 for determining a signal characteristic quantity. The determination means 3 receives as input the source signals for which it is desired to determine the value of the characteristic quantity, in the present case the two signals S₁ and S₂.

In the subsequent description, a determination means 3 is chosen which is capable of determining, as characteristic quantity, the spectro-temporal distribution of the energy of the signal considered. The determination means 3 thus comprises a means 4 for transforming the source signal, so as to obtain the representation in a time-frequency plane of the signal. The time-frequency transformation of the signal may be performed by decomposition into a set of MDCT (“Modified Discrete Cosine Transform”) coefficients, or else by a short-term Fourier transform. In the subsequent description, a means for decomposing the source signal into a set of MDCT coefficients will be considered as transformation means 4. A representation of the source signal is then obtained in matrix form. It is on the basis of this time-frequency representation that the value of the quantity characteristic of the source signal will be determined. In particular, the determination means 3 comprises a detection means 5 and an evaluation means 6 making it possible to characterize the matrix obtained with a quantity W.

The detection means 5 can for example, for each source signal S₁, S₂, group the MDCT coefficients of the matrix time-frequency representation into groups of adjacent coefficients called, hereinafter, molecules. The set of molecules detected by the means 5 makes it possible to retrieve the matrix representation of the source signal.

The evaluation means 6 makes it possible to determine the characteristic quantity W₁, W₂, for each source signal, on the basis of the set of its molecules. In particular, a value of this quantity may be determined for each molecule of each source signal. This value then characterizes the energy of the source signal in the time-frequency zone covered by the molecule.

A value W₁ of a quantity characteristic of the source signal S₁, and a value W₂ of a quantity characteristic of the source signal S₂ are thus obtained as output of the evaluation means 6 and therefore of the determination means 3. The values W₁ and W₂ will be watermarked firstly on the initial mixed signal Sₘᵢₓ so as to form the mixed signal Sₒᵤₜ, and will then be used subsequently to separate the source signals S₁, S₂ of the mixed signal Sₒᵤₜ.

The forming device 1 also comprises a watermarking means 7. The watermarking means 7 receives as input the mixed signal Sₘᵢₓ and the values W₁, W₂ of the quantities characteristic of the source signals S₁, S₂. In order to improve the watermarking and the recovery of the watermarked values, the watermarking means 7 can comprise a transformation means 8 making it possible to decompose the initial mixed signal Sₘᵢₓ according to the same MDCT time-frequency representation as that used to decompose the source signals S₁ and S₂.

The decomposed initial mixed signal is then transmitted to a first quantization means 9. The first quantization means 9 makes it possible to quantize the MDCT coefficients, that is to say the matrix time-frequency representation of the initial mixed signal, with a first chosen resolution so as to restore the signal with the desired quality. The first resolution consists in quantizing the MDCT coefficients of the initial mixed signal with a minimum interval between two values. The minimum interval is chosen as a function of the perception of the quantization. In the case of audio signals, if the minimum mismatch between two values is too large, the quantized mixed signal will be perceived differently by the human ear than the initial mixed signal. On the other hand, if the minimum mismatch between two values is sufficiently small, the human ear will not be able to distinguish any difference between the quantized mixed signal and the initial mixed signal.

On the other hand, as the watermarking will be inserted within the intervals of first quantization, these intervals must also be chosen wide enough for it to be possible for the greatest amount of watermarked information to be inserted thereinto.

The quantized MDCT coefficients are thereafter grouped into molecules by a detection means 10. Here the grouping of the MDCT coefficients into molecules makes it possible to obtain an elementary supporting medium for the watermarking on which it is possible to encode a considerably more significant amount of information than on a single MDCT coefficient. It is therefore on the molecules of the quantized mixed signal that the values W₁, W₂ of the quantities characteristic of the molecules of the source signals will be watermarked.

It is in particular possible to choose a grouping of the MDCT coefficients of the initial mixed signal into molecules which is analogous to the grouping obtained with the MDCT coefficients of the source signals, that is to say the detection means 5 and 10 may be analogous. In this case, if the values W₁, W₂ represent the energy of a particular molecule of each source signal, these values will be able to be watermarked on the corresponding molecule of the initial mixed signal (that is to say the one covering the same zone of the time-frequency plane). Moreover, in this case the values W₁, W₂ will be able to represent the relative energy of each of the molecules of the source signals with respect to the corresponding molecule of the mixed signal, that is to say an energy ratio. The value of the energy of the mixed-signal molecules is then transmitted by the detection means 10 to the evaluation means 6 so that the latter can calculate the energy ratio. Other information useful for separation may also be encoded according to the room available, for example the “form” of the molecules of the source signals, that is to say the more or less precise arrangement of the values of the MDCT coefficients within a molecule.

The watermarking means 7 then comprises a second quantization means 11 which receives the quantized MDCT coefficients grouped into molecules of the mixed signal and the values W₁, W₂. The second quantization means 11 makes it possible to quantize the matrix representation of the mixed signal with a second resolution chosen so as to be able to be detected during separation of the source signals. The second resolution consists in quantizing the minimum interval of the first quantization, with a second minimum interval, that is to say consists in introducing; into the levels of first quantization, over-levels. The second minimum interval is chosen as a function of the detection during source separation. If the second minimum interval is too small, the value watermarked during the second quantization will not be able to be detected correctly.

On the other hand, as the watermarking will be coded by the over-levels of the second quantization, the intervals between these over-levels must also be chosen small enough so that the greatest possible amount of information can be watermarked. The amount of information that can be watermarked therefore depends on the first and on the second quantization.

The principle of the watermarking is therefore a modification of the quantization levels of the MDCT coefficients making up the mixed signal molecule. The modification of the quantization levels is inaudible or hardly audible since it is performed in the determined interval of first quantization, but remains detectable for the separation of sources since it is performed with a determined interval of second quantization.

Finally, the watermarking means 7 comprises an inverse transformation means 12. The inverse transformation means 12 performs the transformation inverse to that performed by the transformation means 4. In the present case, the means 12 performs a transformation by inverse MDCT decomposition (IMDCT). A temporal representation of the watermarked mixed signal is then obtained, which constitutes the mixed signal Sₒᵤₜ. A mixed output signal Sₒᵤₜ with the same temporal representation as the initial mixed signal Sₘᵢₓ, but comprising a watermarking that is hardly if at all audible and detectable for source separation, is therefore obtained at the output of the forming device 1. The mixed signal Sₒᵤₜ can thereafter be transmitted or applied to a recording medium. In the case for example of a compact disc, the mixed signal Sₒᵤₜ firstly undergoes a uniform scalar quantization on 16 bits (which corresponds to the audio CD format), and then is applied to a compact disc. The uniform scalar quantization on 16 bits is an exemplary processing limiting the detection of the second quantization performed by the watermarking means.

A mixed signal Sₒᵤₜ obtained by mixing at least two source signals, and comprising a watermarked value of a quantity characteristic of at least one of the source signals is thus obtained at the output of the forming device 1. The mixed signal Sₒᵤₜ exhibiting the same temporal representation as the initial mixed signal Sₘᵢₓ, and the values of characteristic quantities being watermarked so as to be hardly if at all audible, a conventional device will be able to process the mixed signal Sₒᵤₜ like any mixed signal, while a separating device according to the invention, such as described below, will be able, supplementarily, to at least partially separate one of the source signals from the mixed signal Sₒᵤₜ.

In FIG. 2 there has been schematically represented a first embodiment of a device for separating a source signal contained in a mixed signal Sₒᵤₜ such as defined in the previous paragraph. The separating device 13 receives as input the mixed signal Sₒᵤₜ, and delivers, in the present case, two at least partially separated source signals S′₁ and S′₂. The aim of the separating device 13 is to deliver, at least partially, one or more source signals contained in a mixed signal Sₒᵤₜ which comprises a watermarked value of a characteristic quantity.

The separating device 13 comprises a means 14 for determining the watermarked values W₁, W₂ of the quantities characteristic of the signals to be separated. The means 14 receives as input the mixed signal Sₒᵤₜ and delivers as output the watermarked values W₁, W₂. In the present case, the means 14 also delivers the MDCT coefficient or coefficients of the mixed signal Sₒᵤₜ.

The determination means 14 comprises a transformation means 15 analogous to the means 4 described in FIG. 1. The transformation means 15 makes it possible to decompose the mixed signal Sₒᵤₜ into a matrix of MDCT coefficients.

The MDCT coefficients are thereafter transmitted to a first quantization means 16 analogous to the means 9 described in FIG. 1. The quantization means 16 makes it possible to quantize the MDCT coefficients of the signal Sₒᵤₜ with a first resolution.

The quantized coefficients are thereafter transmitted to a detection means 17 analogous to the means 10 described in FIG. 1. The detection means 17 groups the quantized MDCT coefficients together into molecules, and in particular groups the coefficients together according to the same molecules as those produced by the means 10 described previously.

It is then possible to detect and to determine the watermarked values on the said molecules. Thus, the molecules formed by the means 17 are transmitted to a second quantization means 18 which performs a quantization of the coefficients making up these molecules with a second higher resolution. The second resolution makes it possible in particular to determine the watermarked values W₁, W₂, by reading the levels of second quantization of the coefficients and decoding the values associated with these levels.

The determination means 14 therefore delivers, as output, the values W₁, W₂ of the characteristic quantities, which values may be used for the separation of sources.

The separating device 13 also comprises a processing means 19 receiving the characteristic values of quantities arising from the determination means 14, as well as the coefficients grouped into molecules determined also by the means 14.

The processing means 19 comprises a first separating means 20 capable of separating, at least partially, the source signals of the mixed signal. In particular, the values of the characteristic quantities are used, on the MDCT coefficients grouped into molecules, to improve the separation of the source signals performed by the separating means 20. In so far as the characteristic quantities have been determined on the basis of the MDCT coefficients of the source signals, it is on the basis of the MDCT coefficients of the mixed signal Sₒᵤₜ that it will be possible to retrieve the MDCT coefficients of the source signals, and therefore that a separation of the source signals is effected. For example, each molecule of each source signal to be separated is estimated by the mixed-signal molecule assigned the relative energy level of the molecule of the source signal in question (value of the characteristic quantity) as determined during the detection of the watermarked value. Optionally, the other watermarked information can intervene to refine the estimation of the molecule of the source signal, in particular if information characterizing the form of the molecule of the source signal has also been encoded.

The MDCT coefficients separated by the separating means 20 are then transmitted to an inverse transformation means 21 analogous to the means 12 described in FIG. 1. The means 21 makes it possible to transform the separated MDCT coefficients into temporal signals S′₁ and S′₂ corresponding, at least partially, to the source signals S₁, S₂.

In FIG. 3 there has been represented a second embodiment of a forming device 22 according to the invention. In this embodiment, the elements identical to those of the first embodiment are identified with the same references. The forming device 22 receives as input at least two source signals S₁, S₂ and provides, as output, two different mixed signals Sₒᵤₜ₁, Sₒᵤₜ₂, which correspond to stereo signals.

The device 22 comprises a mixing means 23 receiving the two source signals S₁, S₂ and providing a first initial mixed signal Sₘᵢₓ₁ and a second initial mixed signal Sₘᵢₓ₂. In particular, the mixing means 23 performs different mixing operations to form the two signals Sₘᵢₓ₁ and Sₘᵢₓ₂, so as to obtain two stereo pathways conferring a sound spatialization effect. This spatialization effect involves in particular the introduction of multiplicative factors and of delays which differ on the two pathways. The mixing operations on the two source signals can then be represented in the form of a mixing matrix in the frequency domain, after application of a frequency transform of the signals. The mixing operation then consists of a multiplication of a source signal vector (comprising the two source signals as components) by the mixing matrix, to obtain an initial mixed signals vector (comprising the two initial mixed signals as components). In the case considered, the mixing matrix comprises four components which each represent, for each value of the frequency, the contribution of one of the source signals in one of the initial mixed signals. These components can vary over time.

The device 22 comprises a first determination means 24. Here the first determination means 24 determines the components of the mixing matrix corresponding to the mixed signal Sₘᵢₓ₁. These components are the mixing parameters making it possible to obtain the initial mixed signal Sₘᵢₓ₂ on the basis of the source signals S₁ and S₂. These components therefore represent a value W₁ of a quantity characteristic of the mixing leading to the mixed signal Sₒᵤₜ₂, namely the mixing parameters which make it possible to obtain the mixed signal Sₒᵤₜ₁.

The device 22 comprises a second determination means 25. Here the second determination means 25 determines the components of the mixing matrix corresponding to the mixed signal Sₘᵢₓ₂. These components are the mixing parameter making it possible to obtain the initial mixed signal Sₘᵢₓ₂ on the basis of the source signals S₁ and S₂. These components therefore represent a value W₂ of a quantify characteristic of the mixing leading to the mixed signal Sₒᵤₜ₂, namely the mixing parameters which make it possible to obtain the mixed signal Sₒᵤₜ₂.

The forming device 22 also comprises a watermarking means 26. The watermarking means 26 receives as inputs the initial mixed signals Sₘᵢₓ₁ and Sₘᵢₓ₂, and the values W₁, W₂, and provides as output the mixed signals Sₒᵤₜ₁ and Sₒᵤₜ₂.

The watermarking means 26 successively comprises a transformation means 8, a first quantization means 9 and a detection means 10. The initial mixed signals are processed successively by these means so as to obtain the MDCT coefficients grouped into molecules, for each of the two signals Sₘᵢₓ₁ and Sₘᵢₓ₂.

The watermarking means 22 comprises a second quantization means 11 receiving the MDCT coefficients grouped into molecules and the values W₁, W₂. The watermarking means 22 makes it possible to insert the values W₁ and W₂ into the MDCT coefficients of the signal Sₘᵢₓ₁ and into the MDCT coefficients of the signal Sₘᵢₓ₂. Thus, the mixed signals Sₒᵤₜ₁, Sₒᵤₜ₂ are watermarked with the values of characteristic quantity corresponding to them. The two mixed signals being different, it is then possible to exploit this difference, and to exploit the knowledge of the mixing parameters carried by W₁ and W₂, so as to separate, at least partially, the source signals on the basis of Sₒᵤₜ₁ and Sₒᵤₜ₂.

Mixed signals Sₒᵤₜ₁, Sₒᵤₜ₂ obtained by mixing at least two source signals, and each comprising a watermarked value of a quantity characteristic of the said mixed signals, namely the components of the mixing matrix that are used to form the said mixed signals, are thus obtained at the output of the forming device 22. The mixed signals Sₒᵤₜ₁, Sₒᵤₜ₂ exhibiting the same temporal representation as the initial mixed signals Sₘᵢₓ₁, Sₘᵢₓ₂, and the values of characteristic quantities being watermarked so as to be hardly if at all audible, a conventional device will be able to process the mixed signals Sₒᵤₜ₁, Sₒᵤₜ₂ like mixed signals, in particular stereo signals, while a separating device according to the invention, such as described below, will be able, supplementarily, to at least partially separate one of the source signals on the basis of the mixed signals Sₒᵤₜ₁, Sₒᵤₜ₂.

In FIG. 4 there has been represented a second embodiment of a separating device 27 according to the invention. In this embodiment, the elements identical to those of the first embodiment are identified with the same references. The separating device 27 receives as input two mixed signals Sₒᵤₜ₁, Sₒᵤₜ₂ and provides, as output, two signals S′₁, S′₂ corresponding, at least in part, to the source signals S₁, S₂.

The separating device 27 comprises a means for determining the watermarked value 28. The means 28 receives as input the signals Sₒᵤₜ₁ and Sₒᵤₜ₂, and provides as output the watermarked values W₁, W₂. The means 28 successively comprises a transformation means 15, a means of first quantization 16 and a detection means 17. The mixed signals Sₒᵤₜ₁, Sₒᵤₜ₂ are processed separately by the means 15, 16 and 17 so as to obtain the grouped MDCT coefficients of each of the mixed signals.

The means 28 finally comprises a means of second quantization 29. The means 29 of second quantization makes it possible to determine the watermarked value W₁ in the mixed signal Sₒᵤₜ₁, and the watermarked value W₂ in the mixed signal Sₒᵤₜ₂. The values W₁, W₂ and the mixed signals Sₒᵤₜ₁ and Sₒᵤₜ₂ are transmitted to a processing means 31 comprising a separating means 32.

The separating means 32 makes it possible to retrieve, at least partially, the source signals on the basis of the values W₁, W₂ and of the mixed signals Sₒᵤₜ₁ and Sₒᵤₜ₂. Indeed, even if the mixing matrix is not invertible when there are more than two source signals, it is possible, under certain conditions, to exploit the knowledge of the mixing matrix used by the mixing means 23, to obtain, on the basis of the mixed signals vector, an estimation of the source signals vector. In particular, the separating means 32 can determine the mixing matrix by virtue of the values W₁ and W₂, and the knowledge of this mixing matrix can allow the separating means 32 to better separate, even partially, the source signals, with respect to the same task without knowledge of this mixing matrix.

In FIG. 5 there has been represented a flow chart representing the various steps of the method for forming a mixed signal according to the invention.

The method comprises a first step 33 in the course of which the value W of a characteristic quantity is determined. Next, in the course of a step 34, the mixing of the source signals is performed so as to obtain an initial mixed signal. Finally, in step 34, the value W of the characteristic quantity is watermarked on the initial mixed signal so as to obtain the mixed signal.

It is also possible to perform the watermarking step 35 before the mixing step 34. In this case, the value W of the characteristic quantity is watermarked on at least one of the source signals, and the mixing step makes it possible to obtain the mixed signal.

FIG. 6 represents a flow chart of the various steps of a mode of implementation of the watermarking step 35.

The watermarking begins with a step 36 in the course of which the initial mixed signal is decomposed into MDCT coefficients. The MDCT coefficients are then subjected to a first quantization, during step 37, and then grouped into molecules during step 38. It may be denoted, however, that steps 37 and 38 may also be reversed.

The grouped coefficients thereafter undergo a second quantization, during step 39, in the course of which the value W of the characteristic quantity is inserted into the mixed signal.

Finally, the MDCT coefficients comprising the watermarked value W undergo an inverse decomposition IMDCT, so as to obtain, as output, the temporal representation of the mixed signal.

In FIG. 7 there has been represented a flow chart representing the various steps of the method of separation according to the invention.

The method comprises a first step 41 in the course of which the Mixed signal is decomposed into MDCT coefficients. The MDCT coefficients are then quantized a first time, during step 42, and grouped into molecules during step 43.

The grouped MDCT coefficients then undergo a second quantization making ,it possible to determine the watermarked value W on the mixed signal. Finally, on the basis of the value W which has been determined in step 44, the separation, at least partial, of a source signal is performed in step 45.

In the case of audio signals, it is thus possible to perform a certain number of major controls during audio listening (volume, tonality, effects) independently on the various elements, of the sound scene (instruments and voices obtained by the separating device). Moreover, one of the significant advantages of the proposed technique is that of being entirely compatible with the audio-CD format: a CD watermarked with the proposed method maybe used as is on any conventional reader (without benefiting from the separation functionalities) without any distinction with a conventional CD by virtue of an inaudible or quasi-inaudible watermarking. Alternatively, a specific reader building in the method of separation according to the invention is of course necessary in order to be able to perform the controls during audio listening.

Other applications relating to the extraction and the augmenting of speech in communication systems may be envisaged. It is for example possible to watermark the speech signal at the level of the emitter (when it is produced under good conditions) before its transmission in a channel which may degrade it (or mix it with other signals), so as to be able to recover this speech signal, on the basis of its degraded or mixed form, at the level of the receiver.

1. A method of formation of one or more mixed signals (Sₒᵤₜ) on the basis of at least two digital source signals (S₁, S₂), in particular audio signals, in which the mixed signal or signals are formed by mixing the source signals, characterized in that a quantity characteristic of a source signal (S₁, S₂) or of the mixing is determined and in that the value (W₁, W₂) of the said characteristic quantity is watermarked on at least one of the signals (S₁, S₂, Sₒᵤₜ).

2. The method according to claim 1, in which the characteristic quantity represents the temporal, spectral or spectro-temporal energy distribution of at least one source signal (S₁, S₂).

3. The method according to claim 1, in which the characteristic quantity represents the spectral contribution in amplitude or energy, at least one determined instant, of at least one of the source signals (S₁, S₂) in the mixed signal or signals (Sₒᵤₜ).

4. The method according to claim 1, in which the characteristic quantity represents the parameters for the mixing of the source signals (S₁, S₂) so as to obtain the mixed signal or signals.

5. The method according to claim 1, in which the value (W₁, W₂) of the said characteristic quantity is watermarked on the source signal or signals before mixing and/or on the mixed signal or signals after mixing.

6. A method of separation intended to separate, at least partially, at least one digital source signal contained in one or more mixed signals obtained according to the method of claim 1, in which the watermarked value (W₁, W₂) of the quantity characteristic of the source signal or of the mixing is determined, and then the mixed signal or signals is or are processed as a function of the said value so as to obtain, at least partially, the said source signal (S′₁, S′₂).

7. A device for forming one or more mixed signals on the basis of at least two digital source signals, in particular audio signals, comprising a means for mixing the said source signals so as to form the mixed signal or signals, characterized in that the device also comprises a means for determining a quantity characteristic of a source signal or of the mixing, and a means for watermarking the value of the said characteristic quantity on at least one of the signals.

8. The device according to claim 7, in which the watermarking means is mounted upstream of the mixing means and is capable of watermarking the value of the characteristic quantity on the source signal or signals.

9. The device according to claim 7, in which the watermarking means is mounted downstream of the mixing means and is capable of watermarking the value of the characteristic quantity on the mixed signal or signals.

10. A separating device intended to separate, at least partially, at least one digital source signal contained in one or more mixed signals exiting the device according to claim 7, comprising a means for determining the watermarked value of the quantity characteristic of the source signal or of the mixing, and a means for processing the mixed signal or signals as a function of the said value able to obtain, at least partially, the said source signal.

11. A mixed signal (Sₒᵤₜ), in particular audio signal, obtained by mixing at least two source signals, comprising a watermarked value of a quantity characteristic of a source signal or of the mixing.

12. An information medium, in particular an audio compact disc, comprising the mixed signal (Sₒᵤₜ) according to claim 11.

13. The method according to claim 2, in which the value (W₁, W₂) of the said characteristic quantity is watermarked on the source signal or signals before mixing and/or on the mixed signal or signals after mixing.

14. The method according to claim 3, in which the value (W₁, W₂) of the said characteristic quantity is watermarked on the source signal or signals before mixing and/or on the mixed signal or signals after mixing.

15. The method according to claim 4, in which the value (W₁, W₂) of the said characteristic quantity is watermarked on the source signal or signals before mixing and/or on the mixed signal or signals after mixing.

16. A method of separation intended to separate, at least partially, at least one digital source signal contained in one or more mixed signals obtained according to claim 2, in which the watermarked value (W₁, W₂) of the quantity characteristic of the source signal or of the mixing is determined, and then the mixed signal or signals is or are processed as a function of the said value so as to obtain, at least partially, the said source signal (S′₁, S′₂).

17. A method of separation intended to separate, at least partially, at least one digital source signal contained in one or more mixed signals obtained according to claim 3, in which the watermarked value (W₁, W₂) of the quantity characteristic of the source signal or of the mixing is determined, and then the mixed signal or signals is or are processed as a function of the said value so as to obtain, at least partially, the said source signal (S′₁, S′₂).

18. A method of separation intended to separate, at least partially, at least one digital source signal contained in one or more mixed signals obtained according to claim 4, in which the watermarked value (W₁, W₂) of the quantity characteristic of the source signal or of the mixing is determined, and then the mixed signal or signals is or are processed as a function of the said value so as to obtain, at least partially, the said source signal (S′₁, S′₂).

19. A method of separation intended to separate, at least partially, at least one digital source signal contained in one or more mixed signals obtained according to claim 5, in which the watermarked value (W₁, W₂) of the quantity characteristic of the source signal or of the mixing is determined, and then the mixed signal or signals is or are processed as a function of the said value so as to obtain, at least partially, the said source signal (S′₁, S′₂).

20. A separating device intended to separate, at least partially, at least one digital source signal contained in one or more mixed signals exiting the device according to claim 8, comprising a means for determining the watermarked value of the quantity characteristic of the source signal or of the mixing, and a means for processing the mixed signal or signals as a function of the said value able to obtain, at least partially, the said source signal.
